(19) United States
(12) Patent Application Publication
(10) Pub. No.: US 2008/0072981 A1
(43) Pub. Date: Mar. 27, 2008

(54) Testing System for Plumbing Leaks

(76) Inventor: Doug Saffell, Rice, TX (US)

Correspondence Address: WILSON DANIEL SWAYZE, JR., 3804 CLEARWATER CT., PLANO, TX, 75025, US

(21) Appl. No.: 11/535,323

(22) Filed: Sep. 26, 2006

(51) Int. Cl. F16L 55/10

(52) U.S. Cl. 138/90; 138/93

(57) ABSTRACT

A system for testing plumbing includes a flexible plug for sealing or unsealing the plumbing, an outer container for connecting to an access line to the plumbing system; a flexible air line connected to the flexible plug. The testing system is sealed when the flexible plug seals the plumbing and when the flexible plug is not sealing the plumbing.

### FIELD OF THE INVENTION

The field of the invention relates to plumbing and more particularly to new plumbing which needs to be tested for leaks.

### BACKGROUND

Whether the plumber is installing new plumbing or installing additional plumbing, the plumber should test the new plumbing or additional plumbing for leaks. In order to test the plumbing for leaks, the drain line of the plumbing should be isolated or plugged so that the plumbing can be filled with fluid such as water and examined for leaks. However, the plug in the drain line will have to be removed so that the new plumbing can be used with uninhibited access to the drain line. In order to remove the plug 106 as shown in FIG. 1 from the drain line, an access hole is formed in the drain line, and the access line 104 is usually provided in the wall of the drain line 102 to allow removal of the plug 106 from the drain line 102. The plug 106 is transferred from the drain line 102 to the access line 104 as shown in FIG. 2 and the fluid is drained from the newly installed plumbing. However, a problem can develop if the plug 106 become stuck as illustrated in FIG. 4 and does not enter the access line 104 properly. Without the plug 106 properly positioned within the access line 104, fluid can enter the access line 104 and flow out into the room. This fluid can cause damage to items within the room and damage to items on other floors below the room.

### SUMMARY THE INVENTION

The present invention prevents fluid from uncontrollably leaving the access line which is connected to a drain line.

The present invention employs a plug which seals the drain line.

The plug of the present invention can be deflated to allow fluid to exit by the drain line and the access line remains sealed so that the fluid does not cause damage.

The access line of the present invention can be sealed so that it will not leak fluid during a pressure test.

The present invention allows residue fluid to be controllable discharged.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a drain line and access line with a plug;

FIG. 2 illustrates the drain line and the access line with the plug in a second position;

FIG. 3 illustrates the testing system for plumbing leaks in accordance with the teachings of the present invention;

FIG. 4 illustrates the drain line and the access line with the plug in a third position.

FIG. 5 illustrates the testing system with the flexible plug being expanded to block the drain line.

FIG. 6 illustrates the testing system with the flexible plug being withdrawn from the drain line.

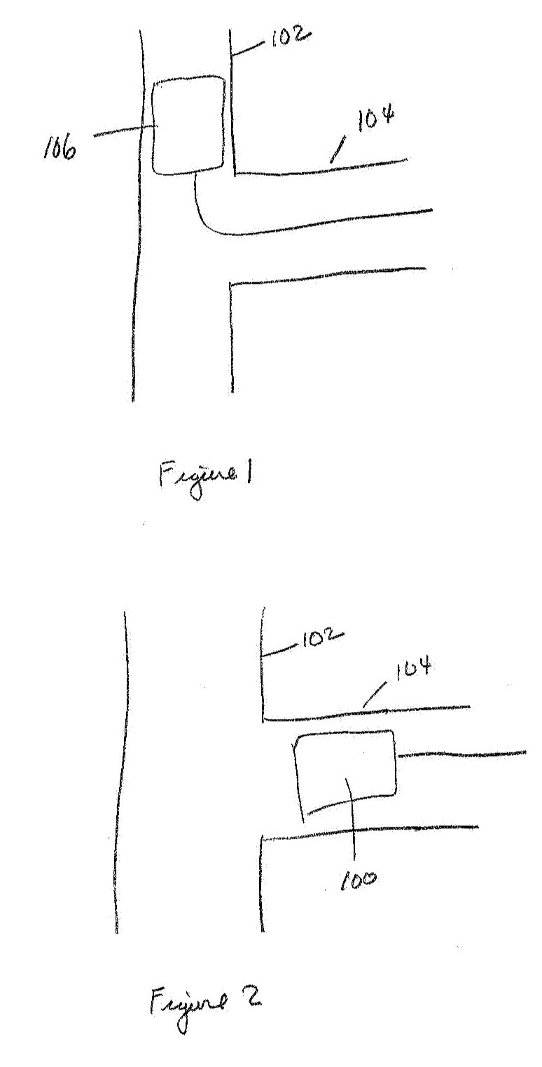

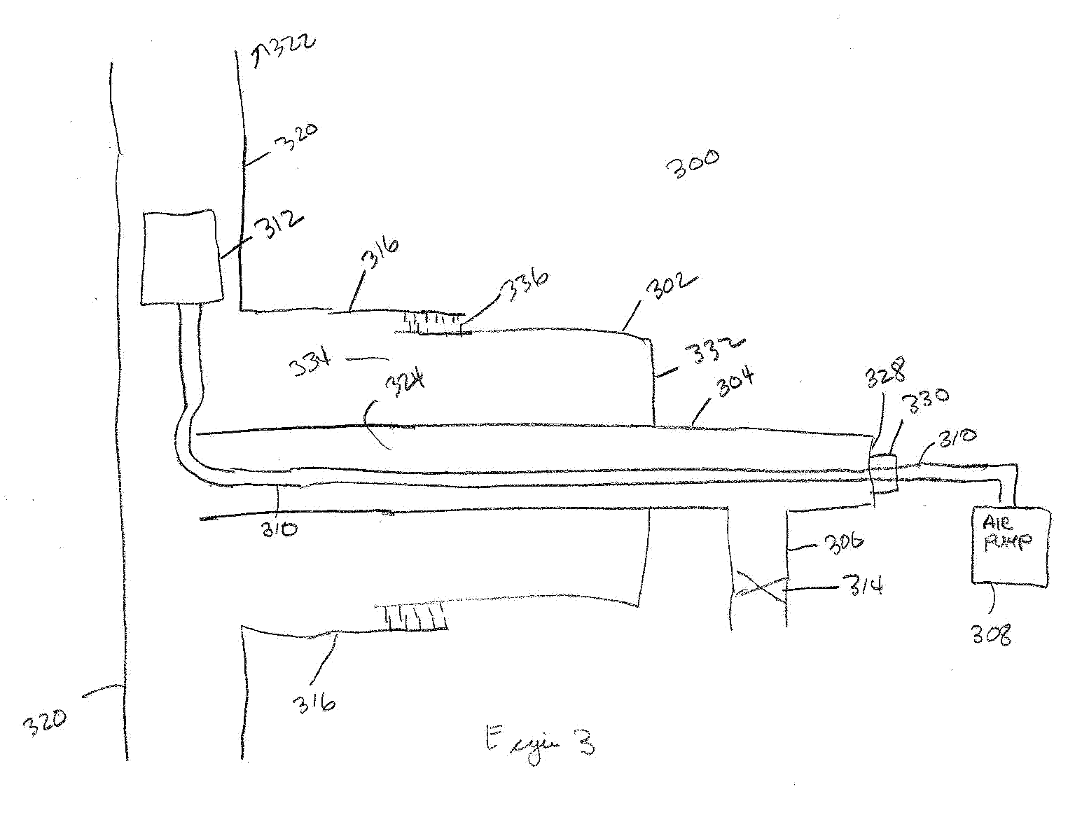

### DETAILED DESCRIPTION

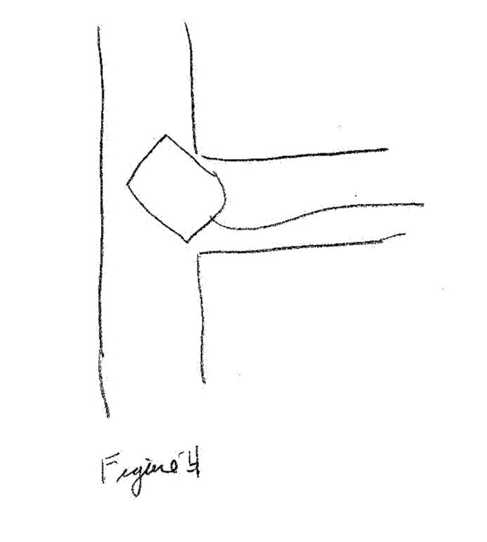

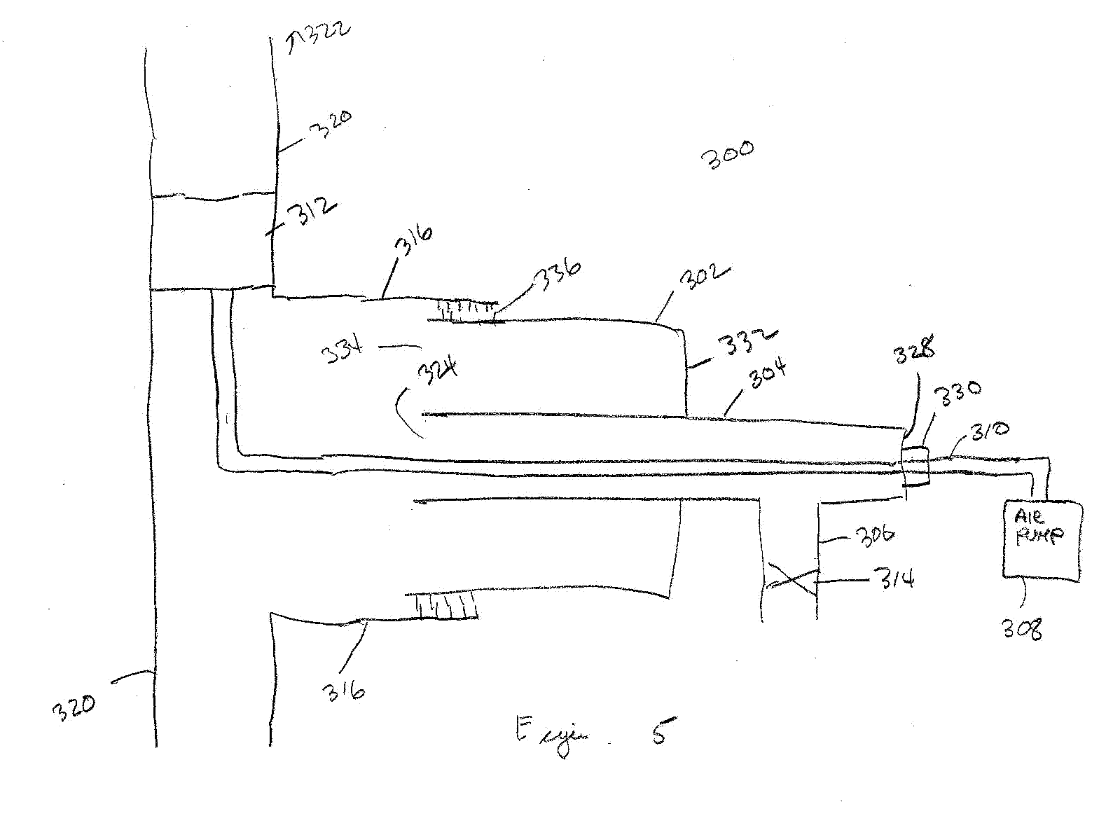

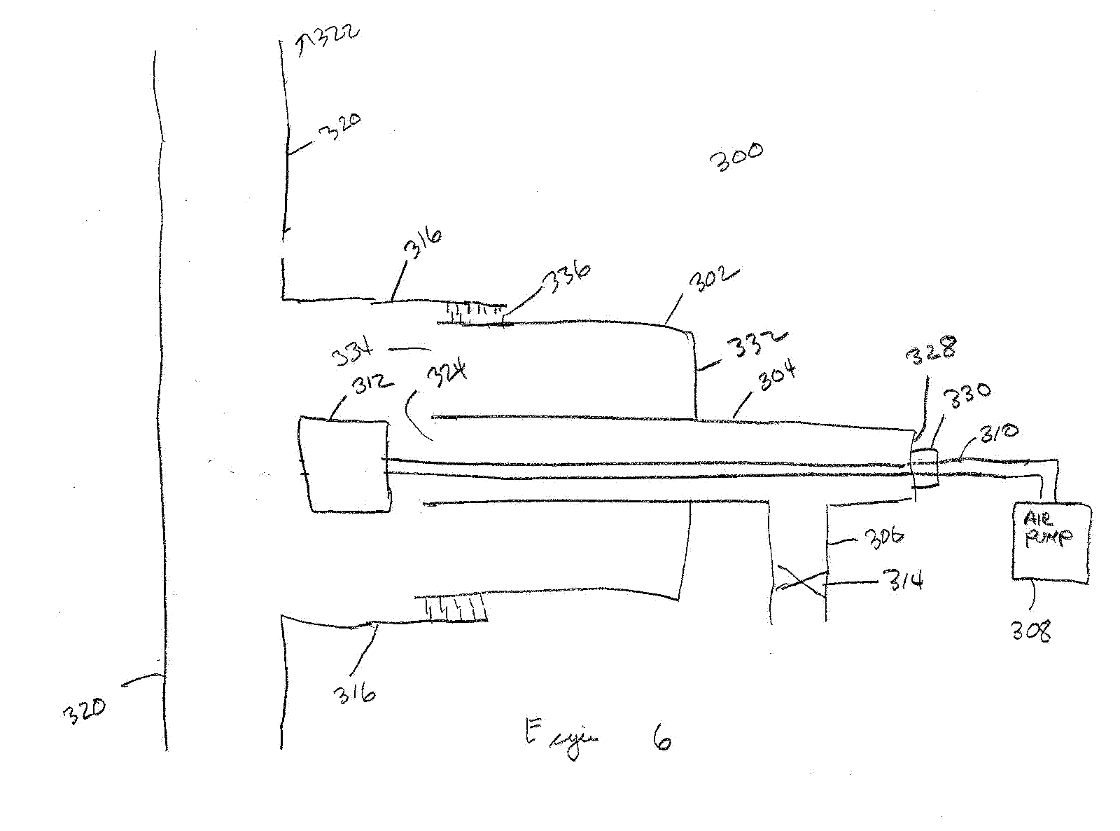

FIG. 3 illustrates the testing system 300 for plumbing leaks in accordance with the teachings of the present invention. FIG. 3 illustrates a drain line 320 which is connected to plumbing to be tested. The teachings of the present invention are applicable to any plumbing including old plumbing to be tested. The testing system 300 includes an inner container 304 which includes an open end 324 for communication with the fluid to be drained and which provides a housing for the flexible air line 310 which extends along the traversed direction of the inner container 304. The inner container 304 extends into the flow path of the drain line 302 so that the open end 324 is in the flow path of the drain line 302. If the flexible plug 312 prematurely deflates, the flexible plug 312 will not become lodged into the discharge side of the drain line 302. The inner container 304 is shown as a cylinder however, other shapes are within the scope of the invention. The inner container 304 includes a closed opposing end 328 which may include a fitting 330 to allow a water tight seal around the flexible air line 310 as the flexible air line 310 extends through the closed opposing end 328. The inner container 304 includes a discharge line 306 which includes a valve 314 to discharge residue fluid from the internal container 304. The valve 314 is closed when the system 300 is testing for leaks. After the fluid has been drained from the plumbing, the valve 314 is opened to drain the residue fluid from the inner container 304 and from the outer container 302. The flexible air line 310 is connected to an air pump 308 which may be a hand pump or a mechanical pump to pump air through the flexible air line 310 and to expand the flexible plug 312. The expanded flexible plug 312 is shown in FIG. 5 so that the flexible plug 312 forms a seal so that the plumbing can be tested. The plug 312 may be constructed from flexible material which expands when pressurized in order to form a seal with the interior walls of the drain line 320.

A system 300 includes an outer container 302 which is shown as a cylinder but may be any suitable shape. The outer container 302 includes a closed end 332 which is formed around the inner container so that the fluid does not leak during the test of the system 300 and includes an opposing open end 334. The outer container 302 includes a sealing device 336 through which is shown as an external threads on a surface of the outer container 302 which mate with internal threads on a interior surface of the access line 316.

In operation, the plug 312 is positioned within the drain line 320 on the side of the plumbing to be tested. The outer container 302 is threaded onto the access line 316, and the air pump 308 inflates the flexible plug 312 to form a seal around the interior surface of the drain line 320. The drain line 320 and the plumbing to be tested are filled with fluid in order to determine if there are any leaks. After the test, the pressure within the flexible plug 312 is released, the flexible plug contracts, and the fluid flows down the drain line 320. The fluid may fill the outer container 302 and the inner container 304 but does not leak out of the inner container 304 and the outer container 302. After fluid has drained from the drain line 302, the valve 314 can be opened to drain any residue fluid from the outer container 302 and the inner container 304. The outer container 302 is removed from the access line 316 and an access cover (not shown) may be placed on the access line 306 so that the drain line 302 does not leak.

FIG. 5 illustrates that the air pump 308 has expanded the flexible plug 302 so that it blocks the drain line 320.

FIG. 6 illustrates that the flexible plug 302 has been withdrawn from the drain line 302 by deflating the flexible plug 302.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A system for testing plumbing, comprising:
a flexible plug for sealing or unsealing said plumbing;
an outer container for connecting to an access line to said plumbing system;
a flexible air line connected to said flexible plug;
wherein said testing system is sealed when said flexible plug seals said plumbing and when said flexible plug is not sealing said plumbing.

2) A system for testing plumbing as in claim 1, wherein said testing system includes an inner housing for connecting to said an outer housing.

3) A system for testing plumbing as in claim 2, wherein said flexible air line extends along said inner housing.

4) A system for testing plumbing as in claim 2, wherein said inner housing includes a discharge line to discharge residue fluid.

5) A system for testing plumbing as in claim 4, wherein said discharge line includes a valve to control the residue fluid.

6) A system for testing plumbing as in claim 1, wherein said flexible air line is connected to an air pump to seal said drain line.

7) A method for testing plumbing, comprising the steps of:
sealing said plumbing with a flexible plug,
connecting an outer container to an access line to close said plumbing;
connecting a flexible air line to said flexible plug.

8) A method for testing plumbing as in claim 7, wherein said method includes the step of connecting an inner housing to said outer housing.

9) A method for testing plumbing as in claim 8, wherein said flexible air line extends along said inner housing.

10) A method for testing plumbing as in claim 8, wherein said method includes the step of forming a discharge line to discharge residue fluid.

11) A method for testing plumbing as in claim 10, wherein said method includes the step of controlling the residue fluid by a valve in the discharge line.

12) A method for testing plumbing as in claim 7, wherein said method includes the step of connecting an air pump to said flexible air line to seal said drain line.
